(19) United States
(12) Patent Application Publication
(10) Pub. No.: US 2005/0030692 A1
(43) Pub. Date: Feb. 10, 2005

(54) Multi-stage impact force enhancing device of an electric nailer

(76) Inventor: Chao-Cheng Lu, Taipei (TW)

Correspondence Address: CHARLES E. BAXLEY, ESQ., 90 JOHN STREET, THIRD FLOOR, NEW YORK, NY, 10038, US

(21) Appl. No.: 10/693,358

(22) Filed: Oct. 24, 2003

(30) Foreign Application Priority Data
May 6, 2003 (CN) 092112269

(51) Int. Cl. H01H 47/00

(52) U.S. Cl. 361/160

(57) ABSTRACT

A multi-stage impact force enhancing device of an electric nailer includes an AC power source, an AC input control circuit, a tripler rectifying filter circuit, a DC steady-state circuit, a timing switch circuit, a decoding counting circuit, an impulse oscillation circuit, multiple energy-storage circuits, multiple solid-state switch circuits, and an electromagnetic coil. Thus, the multi-stage impact force enhancing device can serially discharge a voltage to the electromagnetic coil of electric nailer in a short period of time, thereby generating a larger impact force.

### BACKGROUND OF THE INVENTION

1. Field of the Invention

The present invention relates to a multi-stage impact force enhancing device, and more particularly to a multi-stage impact force enhancing device of an electric nailer, wherein the multi-stage impact force enhancing device generates a multi-stage discharging energy, so that the electromagnetic coil can generate an enhanced impact force.

2. Description of the Related Art

A conventional electric nailer uses the principle of the rectifying filter circuit to transform the alternating current (AC) power source into multiple times direct current (DC) voltage, so as to charge a single electrolytic capacitor which discharges the power to the electromagnetic coil, thereby obtaining the impact force. However, the impact force cannot provide an evenly distributed work required for the impact track of the conventional electric nailer. Thus, it is necessary to increase the capacitance to generate the required impact force, thereby increasing the volume, the weight and costs of fabrication.

### SUMMARY OF THE INVENTION

The primary objective of the present invention is to provide a multi-stage impact force enhancing device of an electric nailer, wherein the multi-stage impact force enhancing device generates a multi-stage discharging energy, so that the electromagnetic coil can generate an enhanced impact force.

In accordance with the present invention, there is provided a multi-stage impact force enhancing device of an electric nailer, comprising an AC power source, an AC input control circuit, a tripler rectifying filter circuit, a DC steady-state circuit, a timing switch circuit, a decoding counting circuit, an impulse oscillation circuit, multiple energy-storage circuits, multiple solid-state switch circuits, and an electromagnetic coil.

The decoding counting circuit drives a charging energy-storage electrolytic capacitor of each stage to serially discharge a voltage to the electromagnetic coil, thereby generating a larger impact force with less capacitance.

The tripler rectifying filter circuit can transform the voltage of the AC power source into three times DC voltage. The tripler rectifying filter circuit has a third time electrolytic capacitor to form a three times voltage, and to function as an energy-storage capacitor for discharging the voltage to the electromagnetic coil.

Further benefits and advantages of the present invention will become apparent after a careful reading of the detailed description with appropriate reference to the accompanying drawings.

### BRIEF DESCRIPTION OF THE DRAWINGS

FIG. 1 is a block view of a multi-stage impact force enhancing device of an electric nailer in accordance with the preferred embodiment of the present invention;

FIG. 2 is a circuit diagram of the multi-stage impact force enhancing device in accordance with the preferred embodiment of the present invention;

FIG. 3 is a graph showing the waveform of the terminal voltage of the electromagnetic coil of the multi-stage impact force enhancing device in accordance with the preferred embodiment of the present invention; and

FIG. 4 is a graph showing the waveform of the terminal current of the electromagnetic coil of the multi-stage impact force enhancing device in accordance with the preferred embodiment of the present invention.

### DETAILED DESCRIPTION OF THE INVENTION

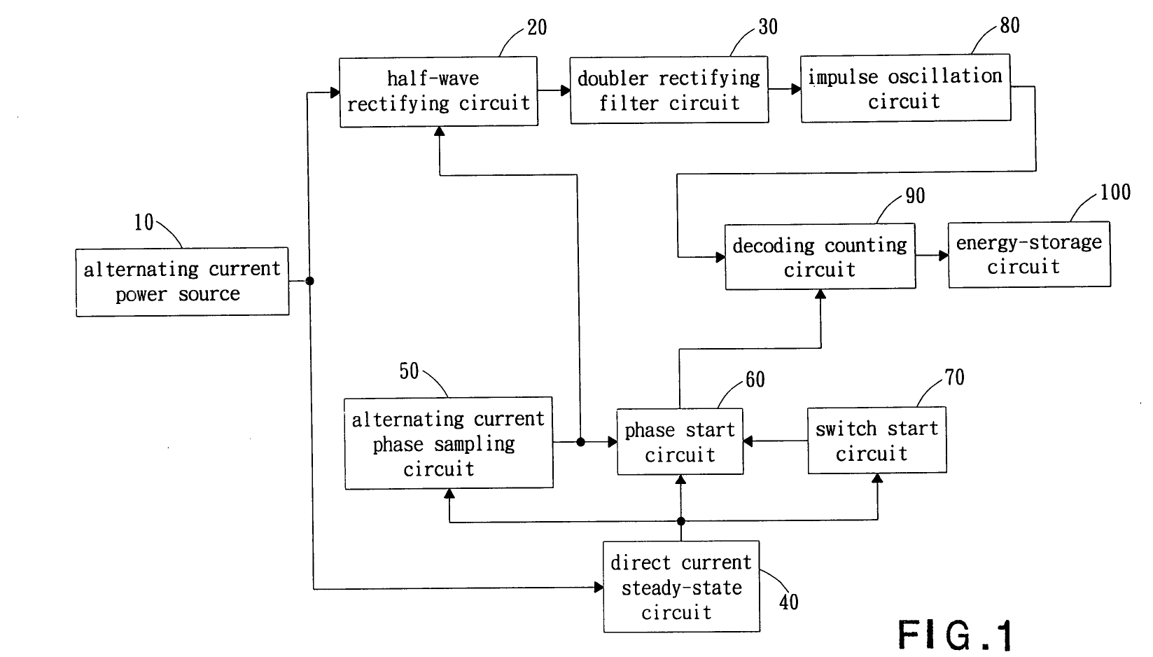

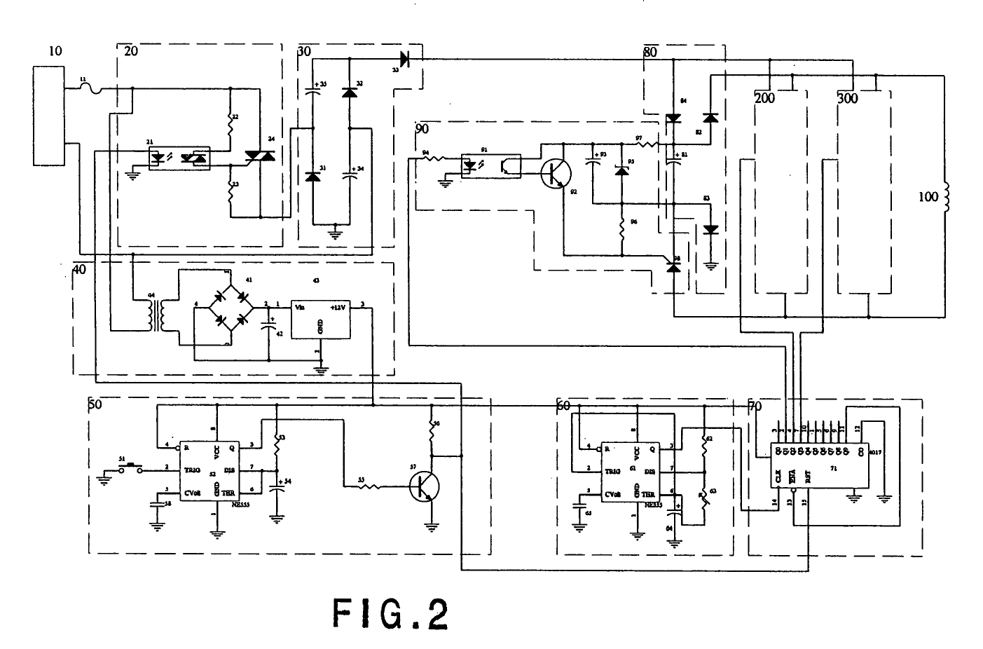

Referring to the drawings and initially to FIGS. 1 and 2, a multi-stage impact force enhancing device of an electric nailer in accordance with the preferred embodiment of the present invention comprises an AC power source 10, an AC input control circuit 20, a tripler rectifying filter circuit 30, a DC steady-state circuit 40, a timing switch circuit 50, a decoding counting circuit 60, an impulse oscillation circuit 70, multiple energy-storage circuits 80, multiple solid-state switch circuits 90, and an electromagnetic coil 100.

The AC power source 10 includes a fuse 11.

The AC input control circuit 20 includes a photo-electric coupler TRIAC 21, two current limited resistors 22 and 23, and a silicon controller 24.

The tripler rectifying filter circuit 30 includes three rectifying diodes 31, 32 and 33, and two electrolytic capacitors 34 and 35.

The DC steady-state circuit 40 includes a bridge rectifier 41, an electrolytic capacitor 42, a steady-state IC (7812) 43, and a transformer 44.

The timing switch circuit 50 is a single steady-state circuit and includes a start switch 51, a counter (IC555) 52, a time constant resistor 53, a time constant capacitor 54, a base resistor 55, a collector resistor 56, a NPN transistor 57, and a capacitor 58.

The decoding counting circuit 60 includes a counter (IC555) 61, a time constant resistor 62, a time constant variable resistor 63, a time constant capacitor 64, and a capacitor 65.

The impulse oscillation circuit 70 is an unsteady-state oscillation circuit, and includes a decoding counter (IC4017) 71.

The energy-storage circuits 80 includes an electrolytic capacitor 81, and three diodes 82, 83 and 84.

The solid-state switch circuits 90 includes a photo-electric coupler transistor 91, a NPN transistor 92, an electrolytic capacitor 93, a current limited resistor 94, a zener diode 95, a gate resistor 96, a resistor 97, and a silicon control rectifier 98.

Referring to FIG. 2, when the start switch 51 of the timing switch circuit 50 is disposed at the “ON” state, the single steady-state period of the counter (IC555) 52 is 1.1*R53*C54. When the counter (IC555) 52 is triggered, its output is disposed at the “Hi” state. At this time, the base of the NPN transistor 57 is also disposed at the “Hi” state, thereby forming a conducting state, so that the collector of the NPN transistor 57 is transformed from the “Hi” state to the “Low” state. When the period of the counter (IC555) 52 is 1.1*R53*C54, the LED of the photo-electric coupler TRIAC 21 stops operation, the CLEAR position of the decoding counter (IC4017) 71 is disposed at the “Low” state, the CLOCK starts to input, and the output terminals Q0 to Q9 output successively.

When the CLEAR position of the decoding counter (IC4017) 71 is disposed at the “Low” state, the CLOCK inputs, and the output terminals Q0 to Q9 output successively and are disposed at the “Hi” state. When the output terminal Q9 is disposed at the “Hi” state, the CLOCK ENABLE is also disposed at the “Hi” state. At this time, the CLOCK stops input, and wait the CLEAR to transform the state at the next time, so as to decode, count and output again.

The CLOCK of the decoding counter (IC4017) 71 is supplied by the decoding counting circuit 60. The high-state time tH of the decoding counting circuit 60 is 0.693*(R62+R63)*C64, and the low-state time tL of the decoding counting circuit 60 is 0.693*R63*C62. The R63 adopts the variable resistor to adjust the frequency of the unsteady-state impulse oscillation circuit 70, so as to provide the required frequency.

When the start switch 51 of the timing switch circuit 50 is disposed at the “OFF” state, the LED of the photo-electric coupler TRIAC 21 is operated to conduct the photo-electric coupler TRIAC 21. At the same time, the gate of the silicon controller 24 is triggered to conduct the silicon controller 24, so that the AC power source 10 inputs an electric power into the tripler rectifying filter circuit 30.

The tripler rectifying filter circuit 30 consists of the three rectifying diodes 31, 32 and 33, the two electrolytic capacitors 34 and 35, and the electrolytic capacitor 81 in the energy-storage circuits 80. The tripler rectifying filter circuit 30 can transform the voltage of the AC power source 10 into the three times DC voltage. The electrolytic capacitor 81 forms the third time voltage, to function as an energy-storage capacitor for discharging the voltage to the electromagnetic coil 100.

When the start switch 51 of the timing switch circuit 50 is disposed at the “ON” state, the AC power source 10 stops inputting the electric power into the tripler rectifying filter circuit 30, while the electrolytic capacitor 81 of the energy-storage circuits 80 stops storing energy and charging.

After the output side of the LED of the photo-electric coupler transistor 91 of the solid-state switch circuits 90 is conducted by the decoding counter (IC4017) 71, the NPN transistor 92 is also conducted, so that the amplified voltage from the tripler rectifying filter circuit 30 passes through the resistor 97 and the zener diode 95 to the electrolytic capacitor 93 to trigger the gate of the silicon control rectifier (SCR) 98, so that the anode and the cathode of the SCR 98 are conducted. At the same time, the electric energy of the electrolytic capacitor 81 of the energy-storage circuits 80 passes through the diode 82 to the electromagnetic coil 100, and is conducted to the diode 83, thereby forming the energy-storage circuits 80. Thus, the energy-storage circuits 80 and the solid-state switch circuits 90 form a first capacitor energy-storage and solid-state switch circuit to discharge the voltage to the electromagnetic coil 100.

Similarly, the multi-stage impact force enhancing device further comprises a second capacitor energy-storage and solid-state switch circuit 200 including the energy-storage circuits 80 and the solid-state switch circuits 90 to discharge the voltage to the electromagnetic coil 100. In addition, the multi-stage impact force enhancing device further comprises a third capacitor energy-storage and solid-state switch circuit 300 including the energy-storage circuits 80 and the solid-state switch circuits 90 to discharge the voltage to the electromagnetic coil 100.

Accordingly, the multi-stage impact force enhancing device generates a multi-stage discharging energy, so that the electromagnetic coil 100 can generate an enhanced impact force. In practice, the multi-stage impact force enhancing device uses the tripler rectifying filter circuit 30 to transform the voltage of the AC power source 10 into the three times DC voltage, and to charge the electrolytic capacitor 81 of each stage. Thus, the multi-stage impact force enhancing device has a sufficient electric energy to serially discharge the voltage to the electromagnetic coil 100 of the electric nailer in a short period of time, thereby generating a larger impact force.

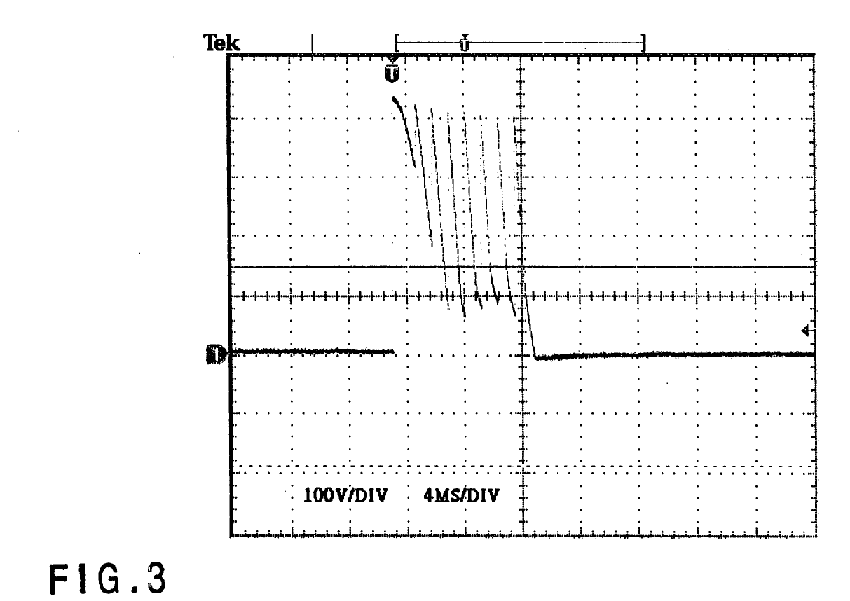

FIG. 3 is a graph showing the waveform of the terminal voltage of the electromagnetic coil of the multi-stage impact force enhancing device in accordance with the preferred embodiment of the present invention.

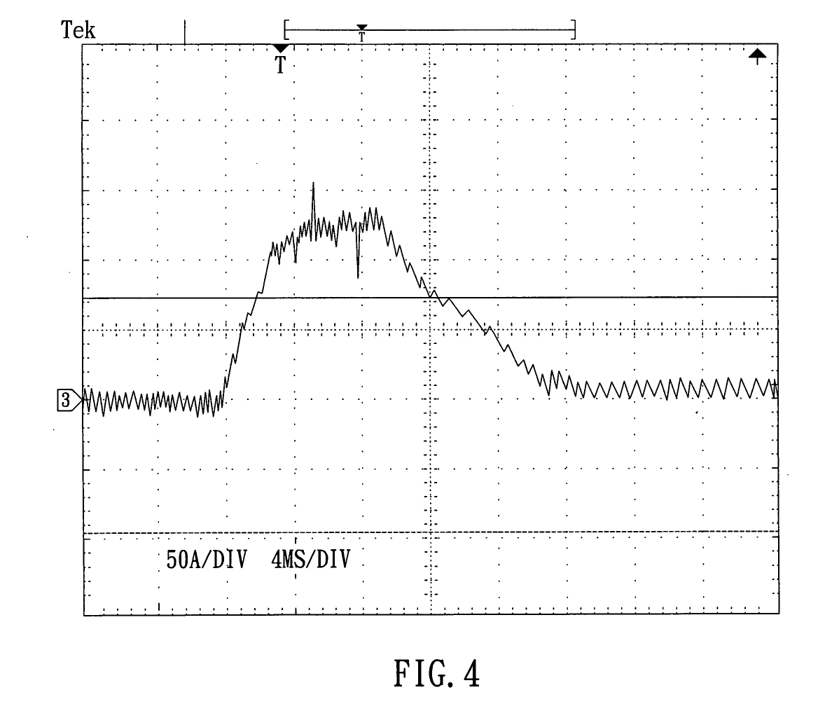

FIG. 4 is a graph showing the waveform of the terminal current of the electromagnetic coil of the multi-stage impact force enhancing device in accordance with the preferred embodiment of the present invention.

While the preferred embodiment(s) of the present invention has been shown and described, it will be apparent to those skilled in the art that various modifications may be made in the embodiment(s) without departing from the spirit of the present invention. Such modifications are all within the scope of the present invention.

1. A multi-stage impact force enhancing device of an electric nailer, comprising an AC power source, an AC input control circuit, a tripler rectifying filter circuit, a DC steady-state circuit, a timing switch circuit, a decoding counting circuit, an impulse oscillation circuit, multiple energy-storage circuits, multiple solid-state switch circuits, and an electromagnetic coil.

2. The multi-stage impact force enhancing device of an electric nailer in accordance with claim 1, wherein the decoding counting circuit drives a charging energy-storage electrolytic capacitor of each stage to serially discharge a voltage to the electromagnetic coil, thereby producing a larger impact force with less capacitance.

3. The multi-stage impact force enhancing device of an electric nailer in accordance with claim 1, wherein the tripler rectifying filter circuit can transform the voltage of the AC power source into three times DC voltage.

4. The multi-stage impact force enhancing device of an electric nailer in accordance with claim 3, wherein the tripler rectifying filter circuit has a third time electrolytic capacitor to form a three times voltage, and to function as an energy-storage capacitor for discharging the voltage to the electromagnetic coil.

5. The multi-stage impact force enhancing device of an electric nailer in accordance with claim 1, wherein the energy-storage circuits and the solid-state switch circuits form a first capacitor energy-storage and solid-state switch circuit to discharge the voltage to the electromagnetic coil.

6. The multi-stage impact force enhancing device of an electric nailer in accordance with claim 1, further comprising a second capacitor energy-storage and solid-state switch circuit including the energy-storage circuits and the solid-state switch circuits to discharge the voltage to the electromagnetic coil.

7. The multi-stage impact force enhancing device of an electric nailer in accordance with claim 1, further comprising a third capacitor energy-storage and solid-state switch circuit including the energy-storage circuits and the solid-state switch circuits to discharge the voltage to the electromagnetic coil.
